(19) United States
(12) Patent Application Publication
(10) Pub. No.: US 2008/0073396 A1
(43) Pub. Date: Mar. 27, 2008

(54) Storage box assembly for motorcycle

(75) Inventors: Chih-Chang Chiang, Taichung County (TW); Mien-Hu Wen, Taipei City (TW)

Correspondence Address: BACON & THOMAS, PLLC, 625 SLATERS LANE, FOURTH FLOOR, ALEXANDRIA, VA, 22314, US

(73) Assignee: Mien-Hu WEN, TAIPEI CITY (TW)

(21) Appl. No.: 11/595,946

(22) Filed: Nov. 13, 2006

(30) Foreign Application Priority Data
Sep. 27, 2006 (TW) 95217288

(51) Int. Cl. B62J 9/00

(52) U.S. Cl. 224/413; 280/202

(57) ABSTRACT

A storage box assembly includes a mounting base for mounting to a rear luggage carrier of a motorcycle, a first locating device upwardly extending from the mounting base, a second locating device upwardly extending from the mounting base and controllable to move relative to the first locating device, a storage box, which has a first retaining recess for receiving the first locating device and at least one second retaining recess for receiving the second locating device, and a control device coupled to the mounting base and operable to move the second locating device between a first position where the second locating device engages the second retaining recess to lock the storage box to the mounting base, and a second position where the second locating device is disengaged from the second retaining recess to unlock the storage box for allowing removal of the storage box from the mounting base.

### BACKGROUND OF THE INVENTION

1. Field of the Invention

The present invention relates to motorcycle parts and more specifically, to a storage box assembly having a mounting base mountable to a rear luggage rack of a motorcycle, and a storage box detachably mounted to the mounting base.

2. Description of the Related Art

FIG. 1 illustrates a storage box 2 fixedly provided at the rear side of a motorcycle 1 for storing things. According to this design, screw bolts (not shown) are inserted through the bottom panel of the storage box 2 and fastened to respective mounting through holes on the rear luggage rack 3 of the motorcycle 1 to affix the storage box 2 to the rear luggage rack 3. Therefore, the storage box 2 is fixedly secured to the rear luggage rack 3 and cannot be conveniently removed from the motorcycle 1.

As stated above, the storage box 2 is affixed to the rear luggage rack 3 with screw bolts; therefore, the mounting procedure of the storage box 2 as well as its dismounting procedure are time-consuming and inconvenient. Therefore, the storage box 2 is constantly secured to the rear luggage rack 3 of the motorcycle 1, and will not be frequently conveniently removed from the motorcycle 1 for other purposes. Further, inserting the screw bolts through the bottom panel of the storage box 2 may cause concentration of stress around each mounting through hole on the bottom panel of the storage box 2 through which the associating screw bolt is inserted, thereby resulting possible damage to the bottom panel of the storage box 2. In general, the aforesaid storage box 2 is simply used for carrying things on the motorcycle 1, not applicable for other purposes.

### SUMMARY OF THE INVENTION

The present invention has been accomplished under the circumstances in view. It is one objective of the present invention to provide a storage box assembly for motorcycle, which can rapidly and detachably be installed in the rear luggage rack of a motorcycle, and firmly secured in place when installed.

It is another objective of the present invention to provide a storage box assembly for motorcycle, which can be removed from the motorcycle for other purposes.

To achieve these objectives of the present invention, the storage box assembly comprises a mounting base for mounting to a rear luggage carrier of a motorcycle. The mounting base has a bearing surface. A first locating device upwardly extends from the bearing surface. A second locating device upwardly extends from the bearing surface and is controllable to move relative to the first locating device between a first position and a second position. A storage box has a mounting wall corresponding to the mounting base, at least one first retaining recess formed on the mounting wall for receiving the first locating device, and at least one second retaining recess formed on the mounting wall for receiving the second locating device. A control device is coupled to the mounting base for moving the second locating device relative to the first locating device between the first position where the second locating device engages the at least one second retaining recess to lock the storage box to the mounting base, and the second position where the second locating device is disengaged from the at least one second retaining recess to unlock the storage box for allowing removal of the storage box from the mounting base.

In a preferred embodiment of the present invention, the storage box assembly further comprises two wheels respectively pivoted to a bottom side of the storage box, and a retractable handle mounted on one side of the storage box such that the storage box can be drawn to move on the ground by the wheels thereof after removal of the storage box from the mounting base.

In addition, the control device has a protruding block. A lock is mounted in a front end of the mounting base and provided with a stop block, which is operatable to stop against the protruding block of the control device to constrain the second locating device to the first position when the lock is set in a locking position.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic drawing showing a storage box installed in the rear luggage rack of a motorcycle according to the prior art;

FIG. 2 is a schematic perspective view of a motorcycle, showing the application of a storage box assembly according to a preferred embodiment of the present invention;

FIG. 3 is a top view of the mounting base of the storage box assembly according to the preferred embodiment of the present invention;

FIG. 4 is a bottom view of the mounting base of the storage box assembly according to the preferred embodiment of the present invention;

FIG. 5 is a sectional view of the mounting base of the storage box assembly according to the preferred embodiment of the present invention;

FIG. 6 is a perspective view of the control device of the storage box assembly according to the preferred embodiment of the present invention;

FIG. 7 is a top plain view of the guard plate of the storage box assembly according to the preferred embodiment of the present invention;

FIG. 8 is a schematic drawing showing the connection of the storage box to the mounting base according to the preferred embodiment of the present invention;

FIG. 9 is a schematic sectional view showing the connection of the storage box to the mounting base according to the preferred embodiment of the present invention;

FIG. 10 is a schematic drawing showing the storage box locked to the mounting base according to the preferred embodiment of the present invention;

FIG. 11 is a schematic drawing of the preferred embodiment of the present invention, showing that the sliders are in the third position;

FIG. 12 is an enlarged sectional view of a part of FIG. 11;

FIG. 13 is similar to FIG. 11 but showing that the locating pins of the sliders are engaged into the locating holes of the inner tubes of the retractable handle;

FIG. 14 is similar to FIG. 12 but showing that the engagement block are stopped against the sliders and the locating pins of the sliders are engaged into the locating holes of the inner tubes of the retractable handle, and

FIG. 15 is a schematic drawing showing the storage box independently used.

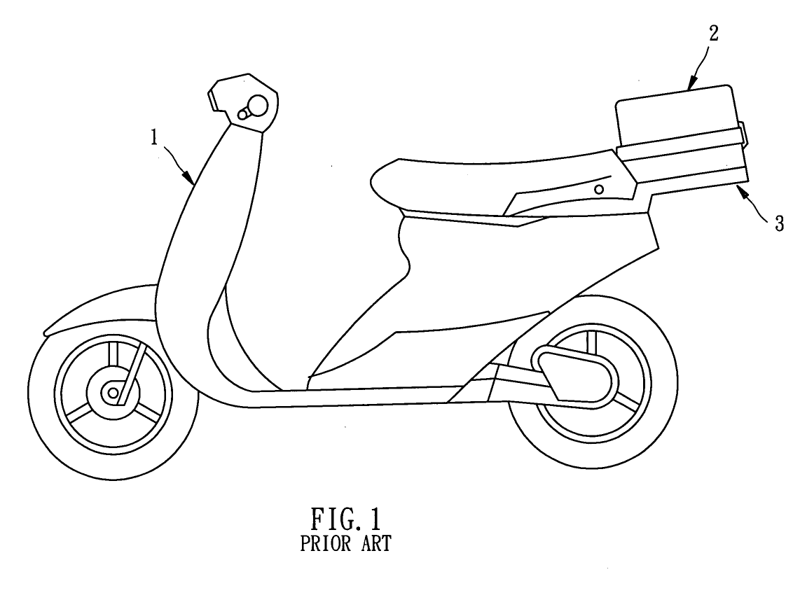

### DETAILED DESCRIPTION OF THE INVENTION

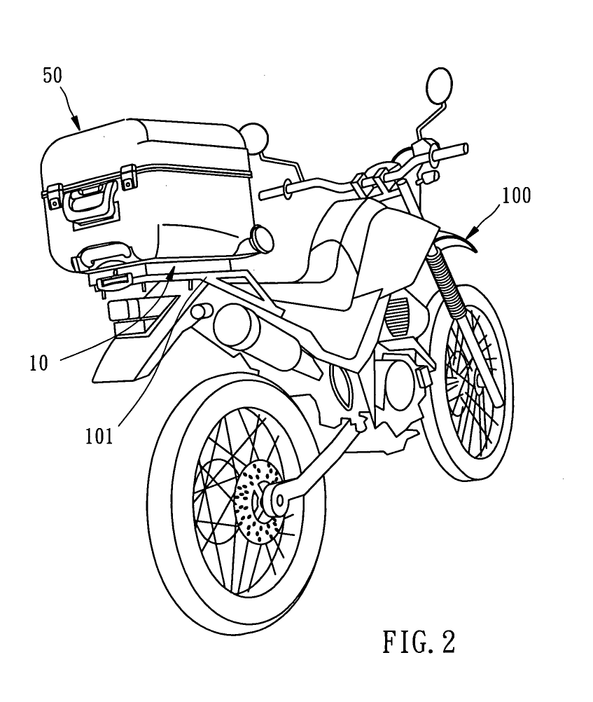

As shown in FIG. 2, a storage box assembly for motorcycle in accordance with a preferred embodiment of the present invention comprises mainly a mounting base 10 mounted on a rear luggage rack 101 of a motorcycle 100 and a storage box 50 mounted on the mounting base 10.

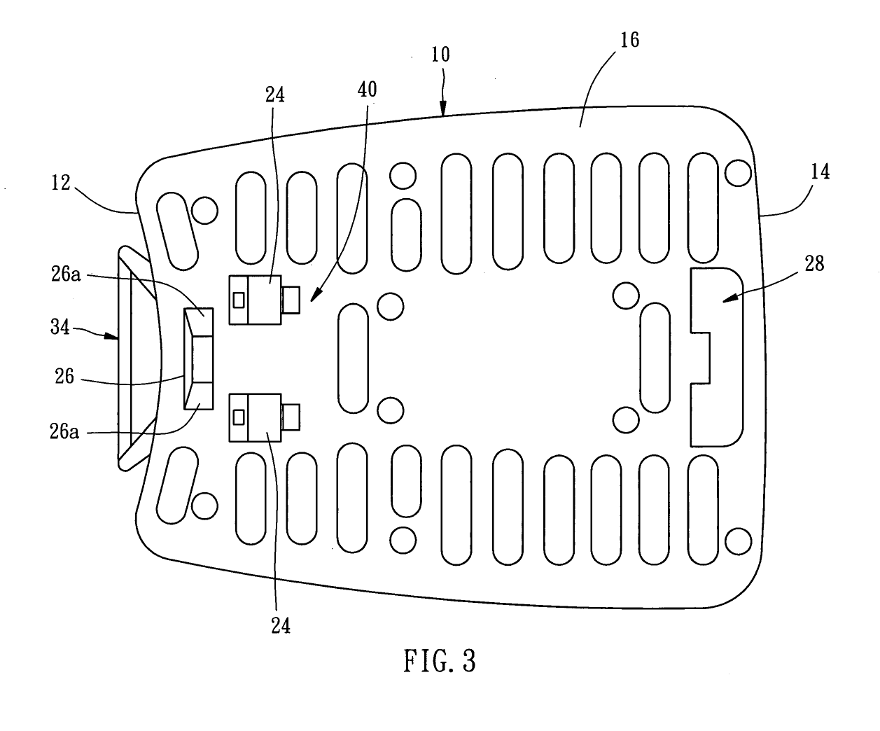

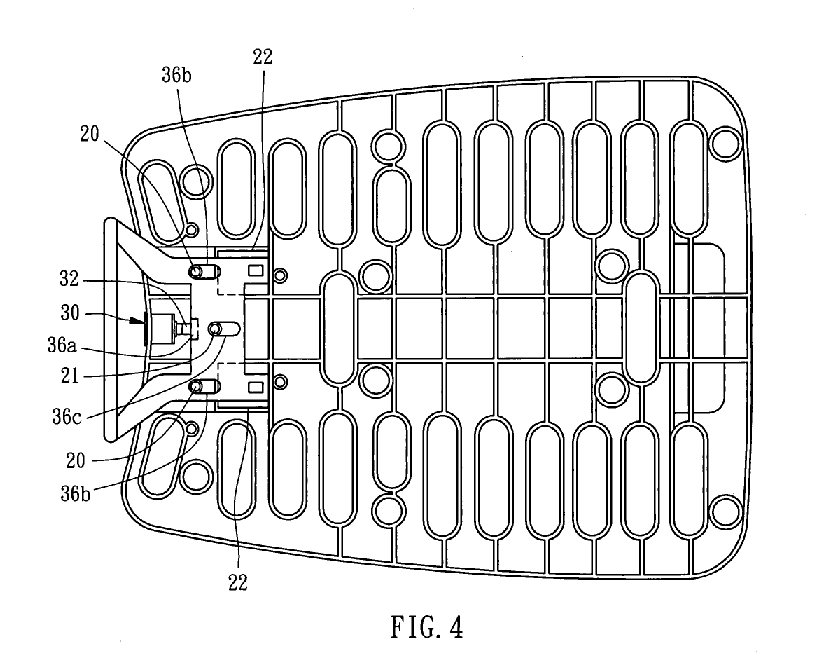

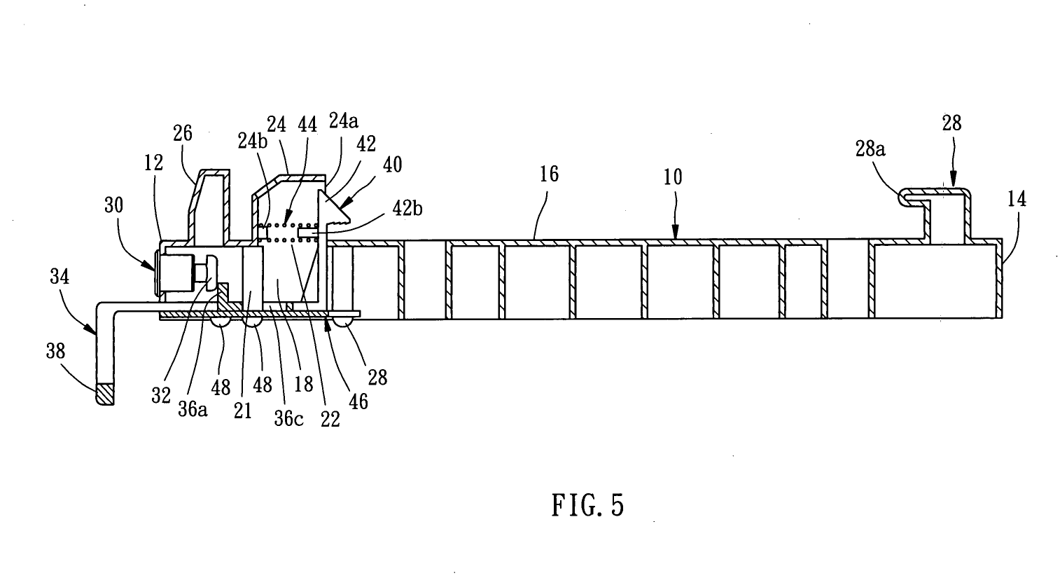

As shown in FIGS. 3-10, the storage box assembly for motorcycle in accordance with the preferred embodiment of the present invention comprises the aforesaid mounting base 10, a first locating device 28, a lock 30, a control device 34, a second locating device 40, two return springs 44, a guard plate 46, the aforesaid storage box 50, a retractable handle 58, two wheels 60, and a cushion pad 68. Detailed description of these components will be recited hereinunder.

Referring to FIGS. 3-5 again, the mounting base 10 is a plate member having a front end 12, a rear end 14 and a bearing surface 16. The mounting base 10 further has a recessed chamber 18, two guiding rods 20, a locating rod 21, two openings 22, two receptacles 24, and an engagement block 26.

The recessed chamber 18 is formed on one side of the mounting base 10 opposite to the bearing surface 16 and disposed near the front edge 12. The two guiding rods 20 and the locating rod 21 are respectively perpendicularly extending from the bottom wall of the recessed chamber 18. The two openings 22 are respectively extending through the bearing surface 16 in communication with the recessed chamber 18. The two receptacles 24 are respectively protruded from the bearing surface 16 corresponding to the two openings 22, each having a receptacle hole 24a respectively disposed in communication with the openings 22 and a pin 24b inside the receptacle hole 24a. The engagement block 26 has two beveled guide edges 26a symmetrically disposed at the left and right sides. According to the present preferred embodiment, the mounting base 10 is fixedly provided at the rear luggage rack 101 of the motorcycle 100, as shown in FIG. 2. The mounting base 10 can be affixed to the rear luggage rack 101 of the motorcycle 100 by any of a variety of conventional mounting techniques.

The first locating device 28 is formed integral with a part of the bearing surface 16 of the mounting base 10 near the rear end 14, having a hook 28a suspending above the bearing surface 16 and extending in direction toward the front end 12 of the mounting base 10.

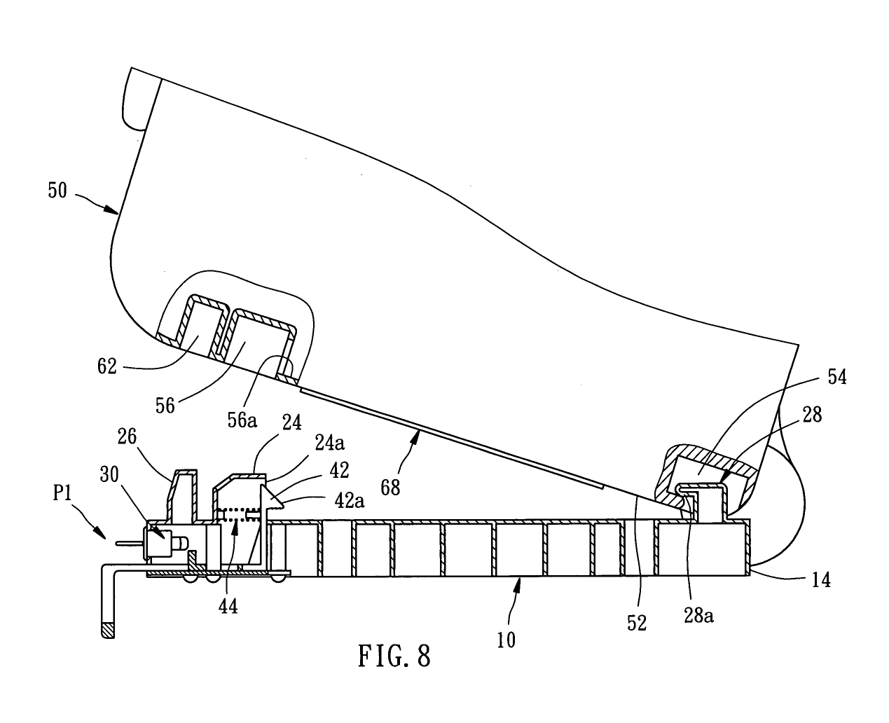

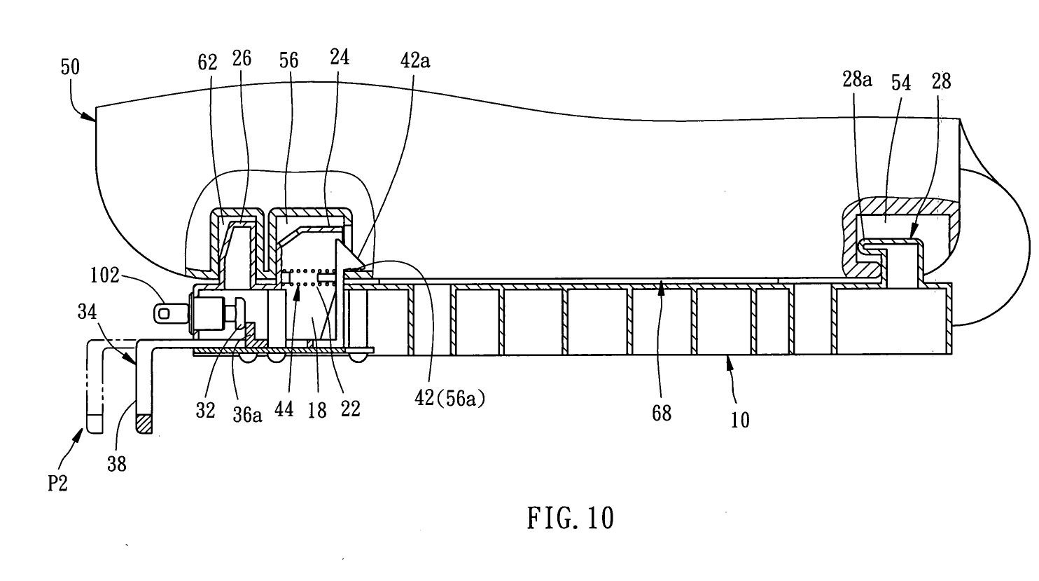

The lock 30 is mounted in the front end 12 of the mounting base 10 and extending to the inside of the recessed chamber 18, having a T-shaped stop block 32. A qualified key 102 can be inserted into the lock 30 and rotated to move the stop block 32 between a locking position shown in FIG. 10 and an unlocking position shown in FIG. 8.

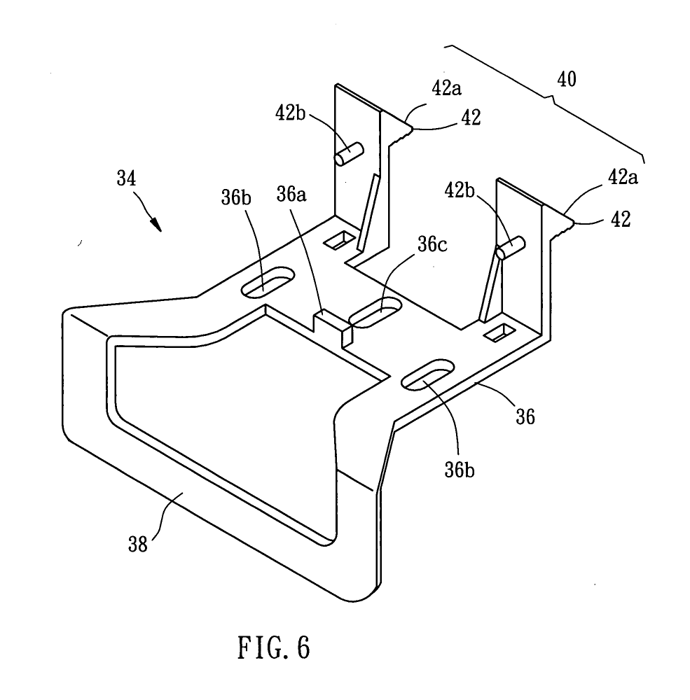

Referring to FIG. 6, the control device 34 comprises a flat base 36, a handle 38 curved downwards from one side, namely, the front side of the flat base 36, a protruding block 36a upwardly extended from the flat base 36 adjacent to the handle 38, two elongated slots 36b cut through the top and bottom sides of the flat base 36 and equally spaced from the protruding block 36 at two sides, and a locating slot 36c cut through the top and bottom sides of the flat base 36 and spaced from the protruding block 36 (opposite to the handle 38) at one side opposite to the handle 38. Further, a second locating device 40 is formed integral with the other side, namely, the rear side of the flat base 36. The second locating device 40 is comprised of two hooks 42 bilaterally upwardly extending from the rear side of the flat base 36. Each hook 42 has a front slop 42a and a back pin 42b. The control device 34 is mounted in the recessed chamber 18 of the mounting base 10, letting the two hooks 42 extend out of the two openings 22 of the mounting base 10 into the two receptacles 24 such that the guiding rods 20 and locating rod 21 of the mounting base 10 are respectively inserted through the elongated slots 36b and locating slot 36c of the control device 34. After installation of the control device 34 in the recessed chamber 18 of the mounting base 10, the control device 34 is movable between a first position P1 as shown in FIG. 8 and a second position P2 as indicated by the imaginary line in FIG. 10.

The two return springs 44 are respectively coupled between the pins 24b in the receptacles 24 and the pins 42b of the hooks 42 to hold the control device 34 constantly in the first position P1 when the control device 34 receives no external pressure.

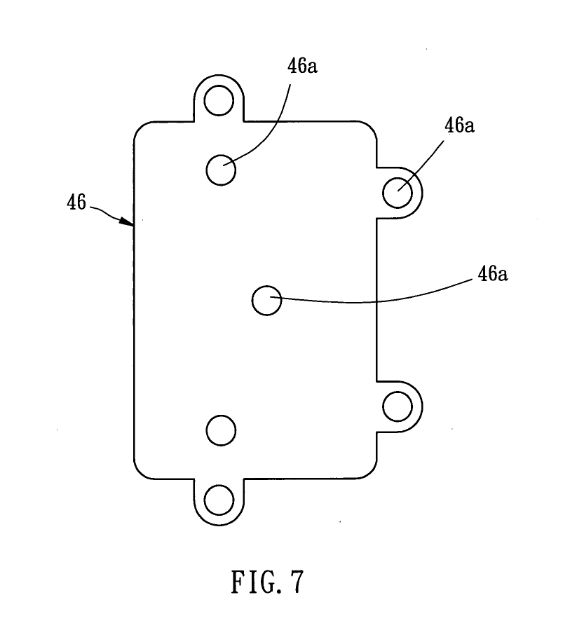

Referring to FIG. 7, the guard plate 46 is covered on the outer side of the flat base 36 of the control device 34, having a plurality of mounting through holes 46a. Fastening elements, for example, locating pins 48 are respectively fastened to and the guiding rods 20 and locating rod 21 of the mounting base 10 through the mounting through holes 46a of the guard plate 46 to affix the guard plate 46 to the mounting base 10, preventing falling of the control device 34 out of the mounting base 10.

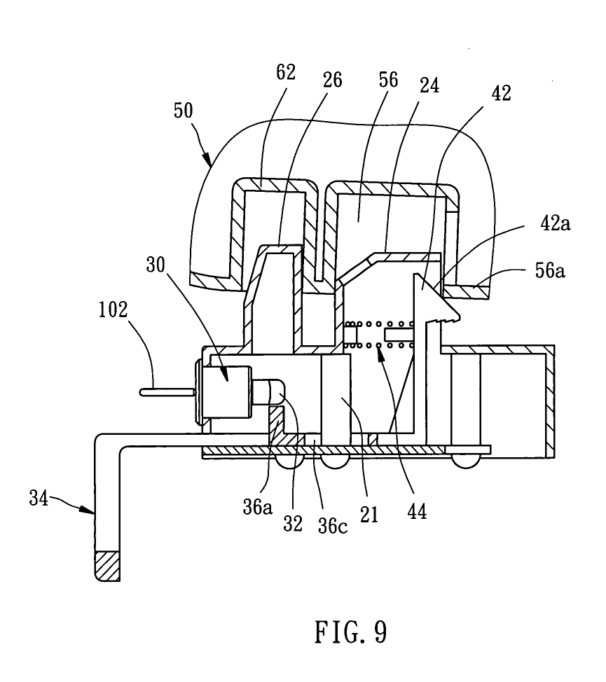

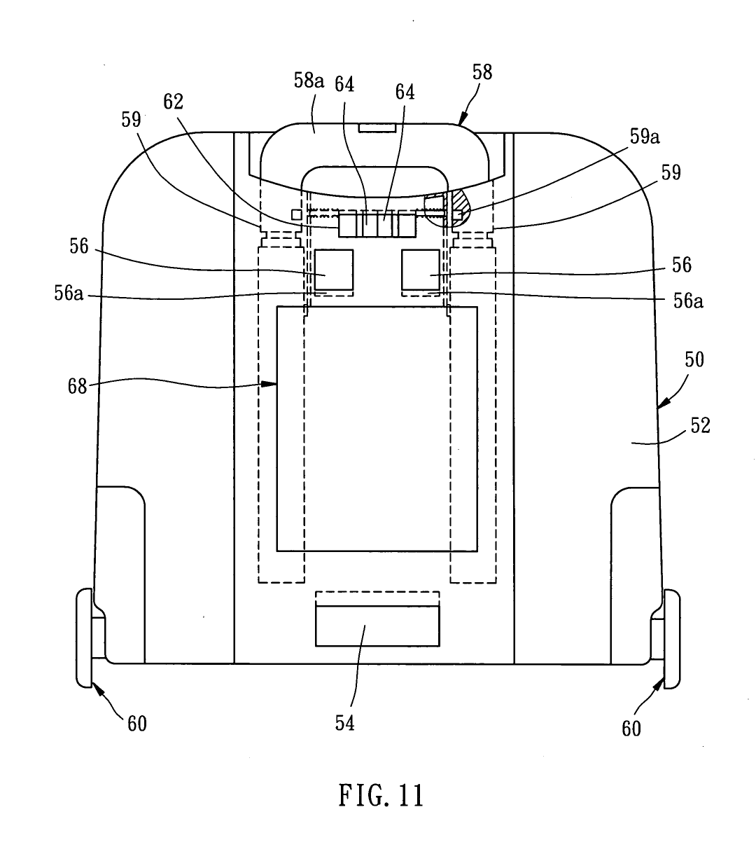

Referring to FIGS. 8 and 11, the storage box 50 has a mounting wall 52 at one side, a first retaining recess 54 and two second retaining recesses 56 respectively formed on the mounting wall 52. The second retaining recesses 56 each have an inside stop edge 56a. Before fastening the storage box 50 to the mounting base 10, the lock 30 must be kept in the unlocking position as shown in FIG. 8. During installation, the first retaining recess 54 of the storage box 50 is coupled to the first locating device 28, and then the storage box 50 is closely attached to the mounting base 10 to force the peripheral edges of the second retaining recesses 56 against the slopes 42a of the hooks 42 (see FIG. 9) and to further move the two hooks 42 backwards, for enabling the two receptacles 24 to be respectively inserted into the second retaining recesses 56. After the two receptacles 24 have been respectively inserted into the second retaining recesses 56, the two return spring 44 immediately force the two hooks 42 out of the receptacle holes 24a of the receptacles 24 into engagement with the inside stop edges 56a in the second retaining recesses 56 (see FIG. 10), and therefore the storage box 50 is firmly secured to the mounting base 10. Further, the hook 28a of the first locating device 28 may be covered with an elastic covering or the like (not shown), assuring positive engagement when the hook 28a is hooked in the first retaining recess 54.

After installation of the storage box 50 in the mounting base 10, rotate the key 102 to move the stop block 32 to the locking position shown in FIG. 10 where the stop block 32 is stopped against the protruding block 36a of the control device 34 to prohibit outward movement of the control device 34, and the control device 34 is kept in the first position P1, i.e., the hooks 42 of the second locating device 40 are kept engaged with the inside stop edges 56a in the second retaining recesses 56, and therefore the storage box 50 is locked to the mounting base 10 and prohibited from vibration during running of the motorcycle. On the contrary, when rotate the key 102 in the reversed direction to move the stop block 32 away from the protruding block 36a of the control device 34, the control device 34 is unlocked and can be pulled outwards to move the control device 34 to the second position P2, i.e., to disengage the hooks 42 from the inside stop edges 56a in the second retaining recesses 56, and therefore the storage box 50 is unlocked and can be taken away from the mounting base 10.

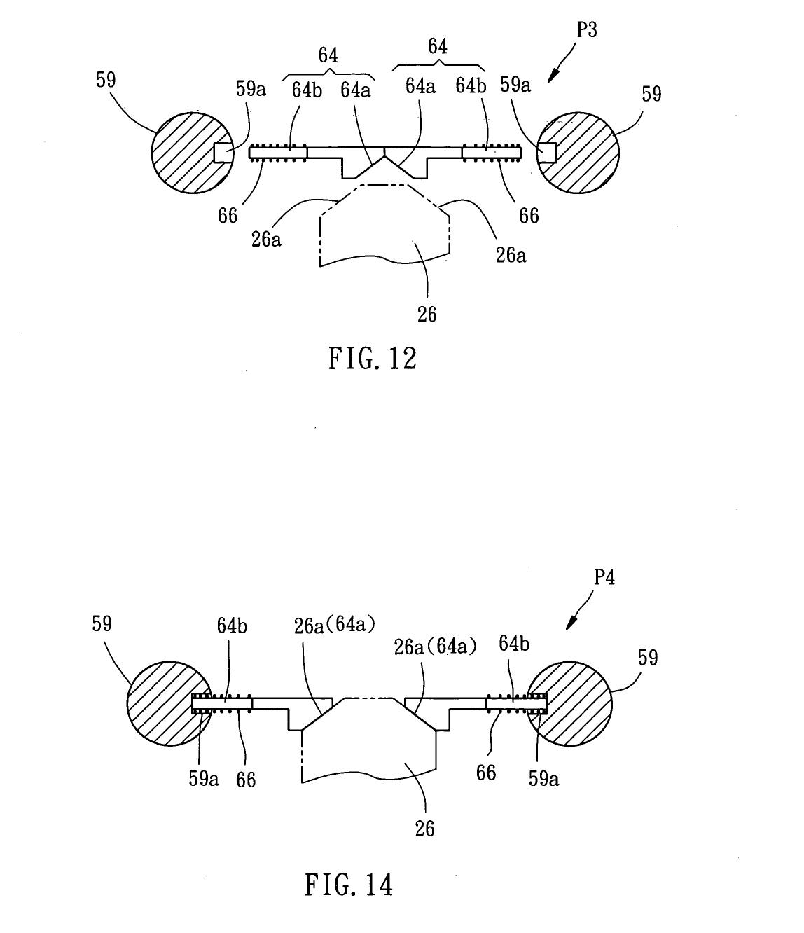

Referring to FIGS. 11 and 12, the retractable handle 58 is mounted on the mounting wall 52 of the storage box 50, and the two wheels 60 are respectively pivoted to the bottom side of the storage box 50. The retractable handle 58 comprises two outer tubes affixed to the mounting wall 52 of the storage box 50, two inner tubes 59 respectively inserted into the outer tubes and axially movable in and out of the outer tubes, and a grip 58a connected between the respective outer ends of the inner tubes 59 outside the outer tubes. The inner tubes 59 each have a locating hole 59a adjacent to the grip 58a. The storage box 50 has a transversely extending opening 62 near the second retaining recesses 56. Two sliders 64 are reversely mounted in the transversely extending opening 62, each having a beveled guide face 64a and a locating pin 64b. Two spring members 66 are respectively mounted on the locating pins 64b of the sliders 64 and stopped against a part inside of the storage box 50, thereby holding the sliders 64 in a third position P3 as shown in FIG. 12 where the engagement block 26 is kept apart from the sliders 64.

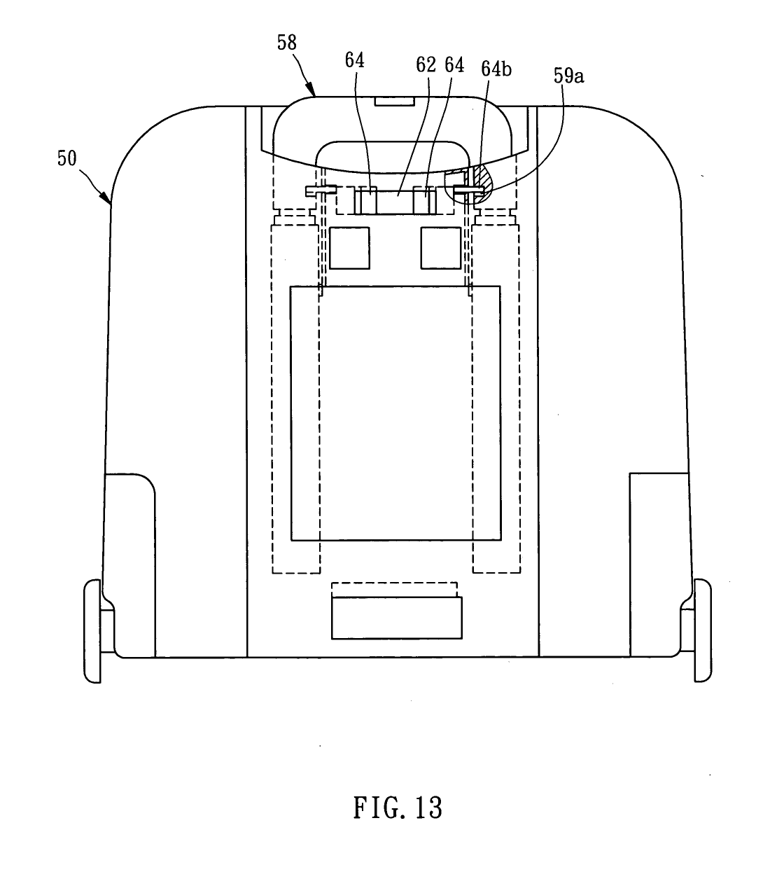

Referring to FIGS. 13 and 14, when the storage box 50 is fastened to the mounting base 10, the engagement block 26 is perpendicularly inserted into the transversely extending opening 62 to force the two beveled guide edges 26a of the engagement block 26 against the beveled guide edges 64a of the sliders 64, and therefore the sliders 64 are moved in reversed directions to a fourth position P4 where the locating pins 64b of the sliders 64 are respectively engaged into the locating holes 59a of the inner tubes 59 to lock the retractable handle 58 in the received position. On the contrary, when the storage box 50 is removed from the mounting base 10, the spring members 66 immediately return the sliders 64 to the third position.

Further, the cushion pad 68 is provided between the storage box 50 and the mounting base 10 to lessen impact between the storage box 50 and the mounting base 10. According to the present preferred embodiment, the cushion pad 68 is affixed to the mounting wall 52 of the storage box 50.

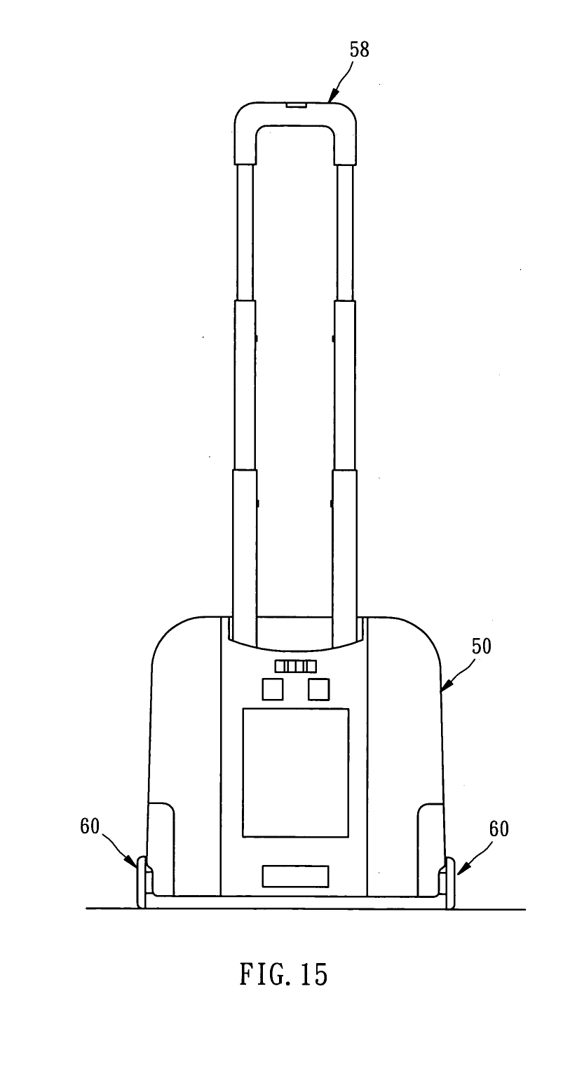

As indicated above, the storage box 50 can easily and rapidly be fastened to or disconnected from the mounting base 10. By means of the hook 28 of the first locating device 28 and the hooks 42 of the second locating device 40, the storage box 50 is firmly secured to the mounting base 10. Further, simply pulling the control device 34 outwards, the storage box 50 is unlocked and can be taken away from the mounting base 10. Further, the storage box 50 can be installed in the rear luggage rack of a motorcycle for carrying things. When the storage box 50 is removed from the motorcycle, the retractable handle 58 can be extended out, and the wheels 60 can be kept in contact with the floor for enabling the storage box 50 to be moved on the floor with less effort, as shown in FIG. 15.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A storage box assembly for a motorcycle, the storage box assembly comprising:
a mounting base for mounting to a rear luggage carrier of the motorcycle, the mounting base having a bearing surface;
a first locating device, which upwardly extends from the bearing surface of the mounting base;
a second locating device, which upwardly extends from the bearing surface of the mounting base and is moveable relative to the first locating device between a first position and a second position;
a storage box having a mounting wall corresponding to the mounting base, at least one first retaining recess formed on the mounting wall for receiving the first locating device, and at least one second retaining recess formed on the mounting wall for receiving the second locating device, and
a control device coupled to the mounting base for moving the second locating device relative to the first locating device between the first position where the second locating device engages the at least one second retaining recess to lock the storage box to the mounting base, and the second position where the second locating device is disengaged from the at least one second retaining recess to unlock the storage box for allowing removal of the storage box from the mounting base.

2. The storage box assembly as claimed in claim 1, wherein the mounting base has a front end, a rear end, a recessed chamber, and at least one opening formed on the bearing surface in communication with the recessed chamber; the first locating device comprises at least one hook integrally upwardly extending from the bearing surface for hooking in the at least one first retaining recess of the storage box; the control device comprises a flat member movably mounted in the recessed chamber and provided with a handle at a front side thereof; the second locating device is formed integral with a rear side of the control device opposite to the handle and provide with at least one hook inserted through the at least one opening of the mounting base for hooking in the at least one second retaining recess of the storage box.

3. The storage box assembly as claimed in claim 2, wherein the mounting base has at least one receptacle upwardly extending from the bearing surface corresponding to the at least one opening, said at least one receptacle having a receptacle hole respectively disposed in communication with said at least one opening; the at least one hook of said second locating device is inserted through said at least one opening and the receptacle hole of said at least one receptacle and hooked in said at least one second retaining recess of said storage box when said storage box is fastened to said mounting base.

4. The storage box assembly as claimed in claim 3, further comprising at least one return member for imparting a pressure to said second locating device to hold said second locating device in said first position.

5. The storage box assembly as claimed in claim 4, wherein said return member is a spring member mounted in said at least one receptacle and stopped between said at least one receptacle and the at least one hook of said second locating device.

6. The storage box assembly as claimed in claim 2, wherein said mounting base has at least one guiding rod respectively perpendicularly extending from a bottom wall of said recessed chamber; said control device has a flat base having a front side formed integral with one end of the handle of said control device, a rear side formed integral with said second locating device and at least one elongated slot for the passing of said at least one guiding rod to guide movement of said control device between said first position and said second position.

7. The storage box assembly as claimed in claim 6, wherein said control device has a protruding block protruded from said flat base; said mounting base has a lock mounted in the front end thereof and operable between a locking position and an unlocking position, said lock having a stop block, which is stopped against the protruding block of said control device to constrain said second locating device to said first position when said lock is in said locking position.

8. The storage box assembly as claimed in claim 7, further comprising a guard plate covered on the flat base of said control device, and at least one locating pin respectively fastened to said guard plate and the at least one guiding rod of said mounting base to affix said guard plate to said mounting base.

9. The storage box assembly as claimed in claim 1, further comprising two wheels respectively pivoted to a bottom side of said storage box, and a retractable handle mounted on one side of said storage box.

10. The storage box assembly as claimed in claim 9, wherein said mounting base has an engagement block protruding from said bearing surface near said front end; said storage box comprises an opening near said at least one second retaining recess, at least one slider mounted in and movable along said opening between a third position and a fourth position, said at least one slider each having a locating pin; said retractable handle having at least one locating hole; said engagement block is inserted into said opening to move said at least one slider to said fourth position and to engage the locating pin of said at least one slider into said at least one locating hole of said retractable handle when said storage box is fastened to said mounting base.

11. The storage box assembly as claimed in claim 10, further comprising at least one spring member respectively mounted in said opening for supporting said at least one slider in said third position.

12. The storage box assembly as claimed in claim 1, further comprising a cushion pad for setting between said storage box and said mounting base.
